(19) United States
(12) Patent Application Publication
(10) Pub. No.: US 2006/0289397 A1
(43) Pub. Date: Dec. 28, 2006

(54) Arc plasma jet and method of use for chemical scrubbing system

(76) Inventor: Imad Mahawili, Grand Haven, MI (US)

Correspondence Address: VAN DYKE, GARDNER, LINN AND BURKHART, LLP, 2851 CHARLEVOIX DRIVE, S.E., P.O. BOX 888695, GRAND RAPIDS, MI, 49588-8695, US

(21) Appl. No.: 11/418,917

(22) Filed: May 5, 2006

Related U.S. Application Data
(60) Provisional application No. 60/681,249, filed on May 16, 2005.

(51) Int. Cl. B23K 9/00; B23K 9/02

(52) U.S. Cl. 219/121.5

(57) ABSTRACT

A chemical scrubbing apparatus includes a first chamber configured to generate a non-rotating arc therein, a second chamber in communication with the first chamber, and a gas injector injecting a first gas into said arc to generate a plasma jet. The apparatus further includes a first inlet for injecting a substance into the first chamber, a mixing region, the substance mixing with the plasma jet in the mixing region whereby the plasma jet disassociates the chemical constituents of the substance in the mixing region, and a second inlet for directing a second gas and/or water into the first chamber at the mixing region. The mixing region directs the chemical constituents into the second chamber, and the second chamber is adapted to quench the chemical constituents to reduce the reactivity of the chemical constituents to thereby maintain their disassociation.

This Application claims priority from U.S. provisional Pat. Application Ser. No. 60/681,249, filed May 16, 2005, entitled ARC PLASMA JET AND METHOD OF USE FOR CHEMICAL SCRUBBING SYSTEM by Applicant Imad Mahawili, Ph.D, which is incorporated by reference in its entirety herein.

### TECHNICAL FIELD AND BACKGROUND OF THE INVENTION

The present application generally relates to an apparatus for scrubbing compounds to abate waste, such as harmful and toxic waste, and, more particularly, to an apparatus that can also be used to synthesize compounds.

Typical chemical abatement processes involve heating to relatively high temperatures using natural gas and/or oxygen flames. For example, toxic chemicals are heated to temperatures typically on the order of about 1000 degrees C. or greater. However, even with these extreme temperatures, not all the chemicals are destroyed which may result in discharge of the residual toxic substances into the environment. Other methods of chemical abatement include the use of landfills, but great care must be taken to avoid contamination of ground water in the region of the land fill. However, neither of these processes are preferred for destroying gaseous waste products, such as produced in the microelectronics industry, because residual toxin gases may escape into the environment.

More and more processes produce toxic by-products. For example, in the semiconductor fabrication industry, effluent streams of nitrogen, freons, fluorinated carbons, silanes, and the like are produced. As previously noted, however, high temperature flame incineration is not suitable for gaseous waste products as incineration does not necessarily eliminate the toxic by-products completely as flames often use high amounts of natural gas.

Consequently, there is a need for simpler chemical abatement process.

### SUMMARY OF THE INVENTION

Accordingly, the present invention provides for an apparatus that uses a plasma jet for either chemical abatement or chemical synthesis.

In one form of the invention, a chemical scrubbing apparatus includes a first chamber and a second chamber that is in communication with the first chamber. The first chamber is configured to generate a plasma jet in the processing chamber. The apparatus further includes at least one inlet for introducing at least one substance, such as a waste medium, into the processing chamber and into the plasma jet whereby the plasma jet disassociates the chemical constituents of the substance in a mixing region, which thereafter flow into the second chamber. The second chamber is configured to quench or atomize the chemical constituents to reduce the reactivity of the chemical constituents to thereby maintain their disassociation.

In one aspect, the apparatus includes a second inlet for introducing a second substance into the first chamber. For example, the second inlet may be used to inject a quenching medium, such as water or water vapor, into the secondary chamber or may inject compressed dry air into the first chamber for oxidizing the substance injected through the first inlet, for example.

In other aspects, the mixing region includes a tube that provides communication between the two chambers. For example, the tube may include a flange to mount the tube between the two chambers, with the flange dividing the apparatus into the two chambers. Preferably, the distal end of the tube is immersed in a quenching medium, such as water, in the second chamber. In addition, the open proximate end of the tube is located below the plasma jet so that the substance and plasma jet flow into the tube. The tube, for example, may be made from a metal, such as stainless steel, Hasteloy, or quartz or alumina, or even plastic, such as polypropylene. The selection of the material is typically dictated by the process variables, for example by the corrosiveness and/or reactivity of the substance or substances being processed. In addition, the tube may vary in length and/or in diameter over a wide range of dimensions depending on the application. For example, in smaller applications the tube may have a length in a range of 1 to 10 inches and, more typically, of about 3 inches. The diameter may vary to vary the flow through the tube. For example, in smaller applications the tube may have a diameter in a range of 0.25 to 6 inches depending on the specific process being employed. Further, the tube may be sized to create laminar or turbulent flow through the tube, with the turbulent flow providing increased mixing of the plasma jet and the substance or substances being processed.

In a further aspect, the first chamber includes an annular negative electrode and a positive electrode passing through at least a portion of the annular negative electrode, with a passageway defined between the electrodes. When the electrodes are powered, such as by a DC power source, an arc is generated between the electrodes. The first chamber also includes an inlet in communication with the passageway between the electrodes for injecting a gas between the electrodes and into the arc to thereby generate the plasma jet. For example, the gas is preferably an insert gas such as argon or nitrogen or the like, though other gases may be used.

According to yet a further aspect, for example, the negative electrode may be mounted in the first chamber by a jacket or cover that is formed from an insulative material, such as insulating polymer, including TEFLON, polypropylene, polyethylene or the like. The negative electrode is formed from a relatively inert material, such as copper, including nickel plated copper, or zinc or chrome plated copper or the like. The positive electrode is formed from a high temperature conducting material, such as tungsten, carbon, or the like. Further, the negative electrode may be cooled, for example, water cooled.

In a further aspect, the positive electrode may be recessed within the annular negative electrode so that its distal end is recessed from the distal end of the negative electrode. For example, the positive electrode may be recessed from the distal end of the annular negative electrode in a range of ⅛″ to ½″ depending on the size of the reactor and the diameter of the passageway provided in the annular negative electrode.

To cool the negative electrode, the negative electrode may comprise a hollow annular member with an inlet port and an outlet port, with the inlet port in communication with a supply of coolant, such as water, which is then circulated through the negative electrode to cool the electrode.

In a further aspect, the inner passage formed in the negative electrode has a diameter in range of ⅛″ to 1″ and, more typically, of about ¼″.

In addition, the distance between distal end of the negative electrode and the open proximate end of the tube may be varied depending on the process and medium being abated.

In another form of the invention, a chemical synthesis apparatus includes a first chamber and a second chamber that is in communication with the first chamber. The first chamber is configured to generate a plasma jet and includes at least one inlet for injecting at least two substances into the first chamber and into the arc whereby the arc associates the substances into a compound or product. The apparatus further includes a mixing region in communication with the second chamber wherein the compound is injected into the second chamber from the mixing region, which is adapted to quench the compound and reduce the reactivity of the resulting compound.

In one aspect, the apparatus includes a second inlet for introducing into the first chamber one of the two substances or for injecting another substance, for example, a quenching medium for quenching the resulting compound. For example, the second inlet may inject water or water vapor into the first chamber and/or may inject compressed dry air into the first chamber for oxidizing one or more of the substances injected through the first inlet, for example.

In other aspects, the mixing region includes a tube, which provides communication between the two chambers. For example, the tube may include a flange to mount the tube between the two chambers. Preferably, the open distal end of the tube is immersed in a quenching medium, such as water, in the second chamber to quench the resulting compound or product.

In a further aspect, the first chamber includes an annular negative electrode and a positive electrode passing through at least a portion of the annular negative electrode, with a passageway defined between the electrodes. When the electrodes are powered, an arc is generated between the electrodes. The first chamber also includes an inlet in communication with the passageway between the electrodes for injecting an inert gas between the electrodes and into the arc to thereby generate the inert plasma jet.

According to yet another form of the invention, a method of chemical abatement includes generating a plasma jet in a first chamber, exposing a waste medium to the jet in the first chamber, mixing the waste medium with the plasma jet to disassociate the chemical constituents of the waste medium into a non-toxic form, flowing the chemical constituents into a second chamber, and quenching the chemical constituents in the non-toxic form in the second chamber to stabilize the disassociated state of the chemical constituents.

In other aspects, the quenching includes exposing the chemical constituents in their non-toxic form to water or water vapor.

In yet another form of the invention, a method of chemical synthesis includes generating a plasma jet in a first chamber, injecting at least two substances into the first chamber to expose the substances to the jet, mixing the substances with the plasma jet wherein they are energized to a more reactive state whereby the substances associate to form a compound or product. The compound is then injected into a second chamber and then quenched to stabilize the compound in its existing form.

In this manner, the present invention provides for a method and apparatus for abating substances or for forming compounds from two or more substances and then stabilizing them their respective forms.

These and other objects, advantages, purposes and features of the invention will be apparent to one skilled in the art from a study of the following description taken in conjunction with the drawings.

### DETAILED DESCRIPTION OF THE DRAWINGS

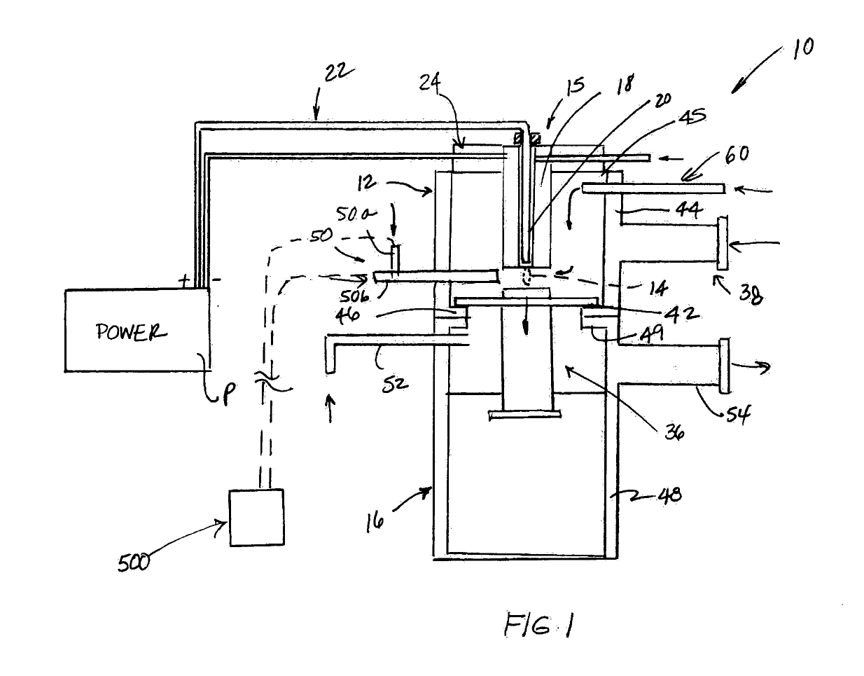

FIG. 1 is a schematic representation of the apparatus of the present invention;

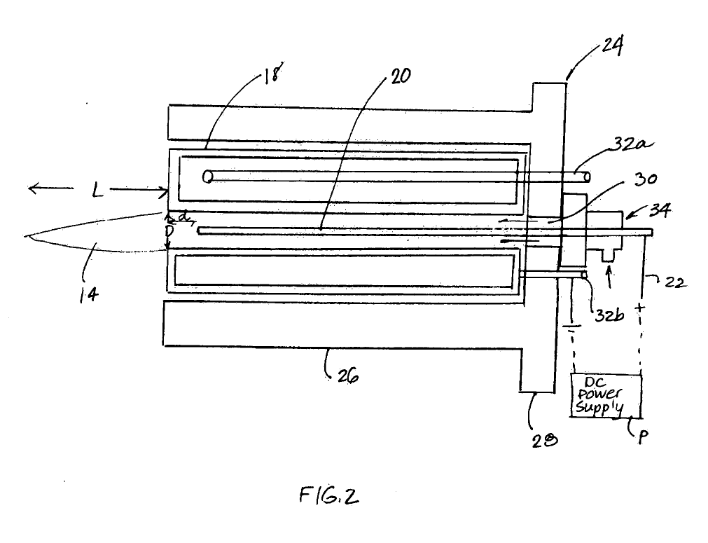

FIG. 2 is an enlarged schematic representation of the plasma jet generator of the apparatus of FIG. 1;

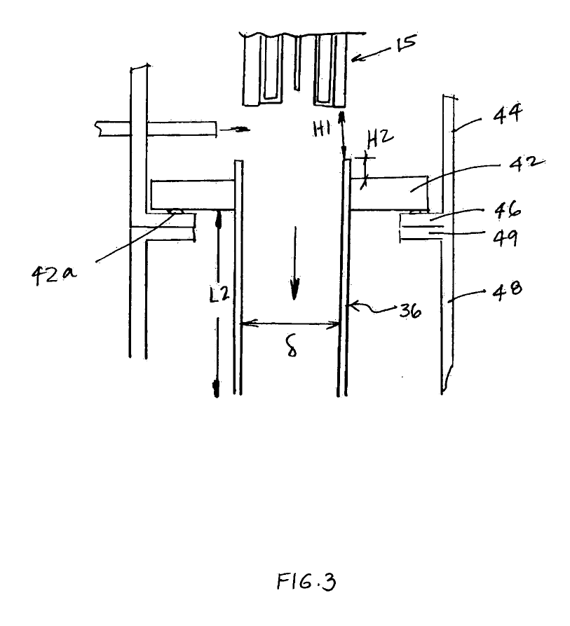

FIG. 3 is an enlarged view of the mixing region of the apparatus of FIG. 1;

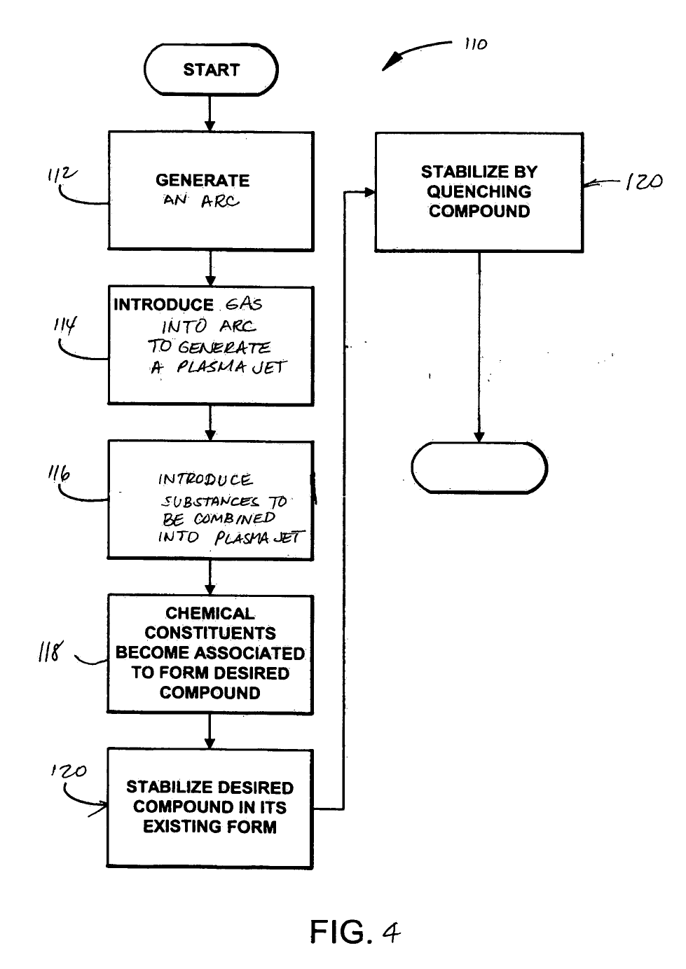

FIG. 4 is a flow chart of a chemical abatement of the present invention;

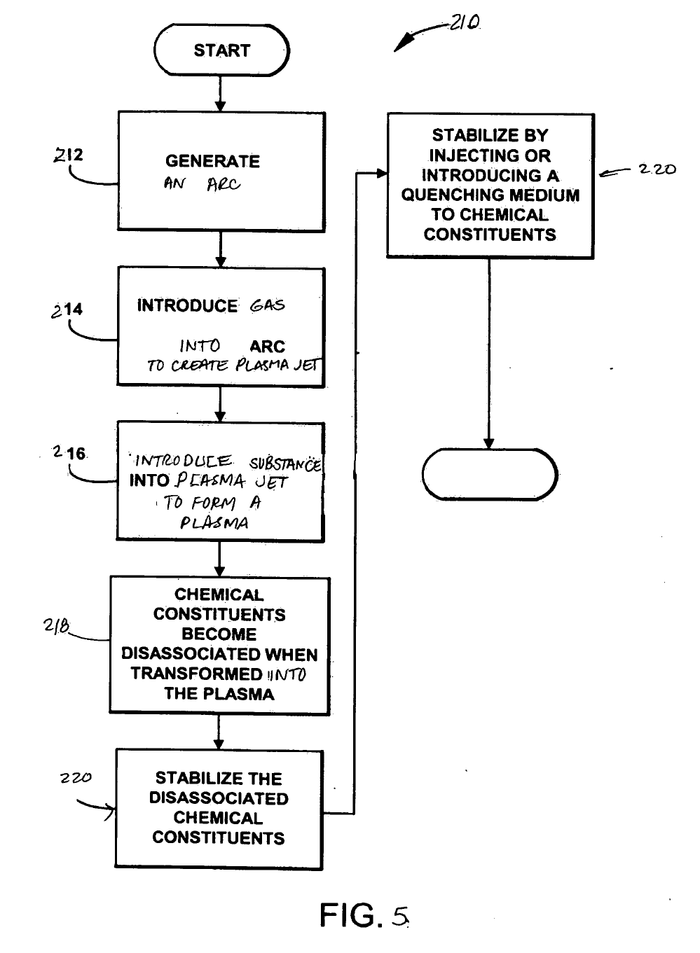

FIG. 5 is a flow chart of the chemical synthesis of the present invention;

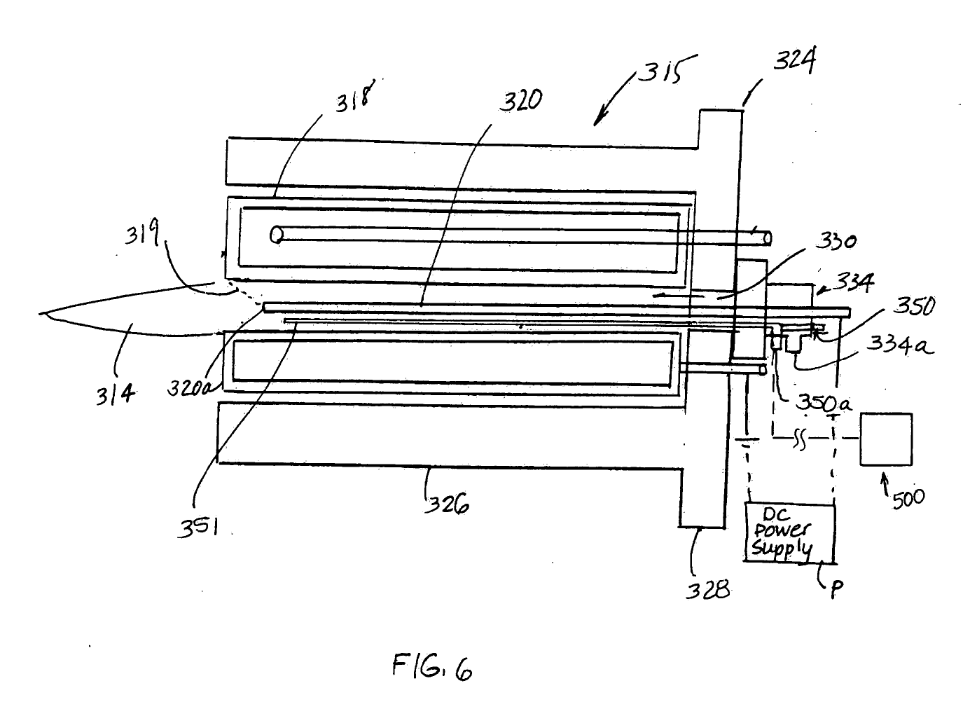

FIG. 6 is a similar view to FIG. 2 illustrating another embodiment of the plasma jet generator of the present invention; and

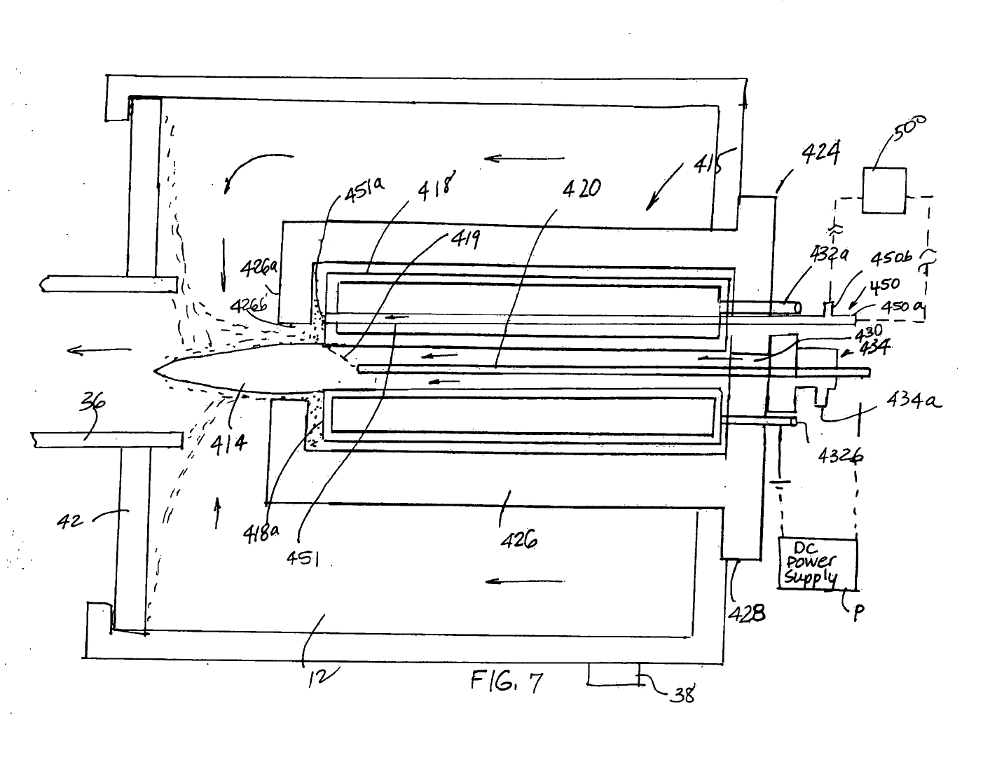

FIG. 7 is a similar view to FIG. 6 illustrating another embodiment of the plasma jet generator of the present invention.

### DETAILED DESCRIPTION OF THE PREFERRED EMBODIMENTS

Referring to FIG. 1, the numeral 10 generally designates an apparatus of the present invention. As will be more fully described below, apparatus 10 may be used for chemical scrubbing, including chemical abatement, or for chemical synthesis. As used in this application the term “synthesis” means a process or reaction for building up a compound from two or more compounds or elements. “Abatement” as used herein means a decrease in amount of a substance or compound, for example by breaking up the elements or simple compounds that form a more complex compound.

Apparatus 10 includes a chamber 12, which is configured to generate a non-rotating or generally stationary plasma jet 14 in the chamber, and a second chamber 16 which is in communication with chamber 12 and which is configured to quench the chemical or chemicals which enter chamber 16 after the chemical or chemicals have been exposed and mixed with the plasma jet in chamber 12, which quenching stabilizes the resulting chemical or chemicals. For example, as will be described in greater detail, apparatus 10 is particularly suitable for processing particulate reactives, including incinerating medical wastes, for neutralizing chemicals, such as sodium hydroxide, for destroying liquids, gases, chemicals, and other wastes.

As best seen in FIG. 1, processing chamber 12 includes a plasma generator 15 that generates the non-rotating plasma jet. Plasma generator 15 includes a negative electrode 18 and a positive electrode 20, which are coupled to a source of power, such as a DC source of power. Electrode 18 preferably comprises a high thermal conductivity material, such as copper, graphite or the like, while electrode 20 comprises a high temperature conducting material, such tungsten, carbon, or the like. In addition, electrode 18 preferably comprises a cooled electrode, for example a water-cooled copper electrode. A discharge arc is generated between electrode 18 and electrode 20 when the electrodes have a voltage applied thereto by the power source P through circuit 22. Typically, the sustained arc current depends on the processing conditions, but typically can have a minimum of 20 to 50 Amperes at voltages in the range of 10 to 30 volts DC. The power supply preferably contains a high frequency starter so that when the power is supplied a high-pressure generally horizontal stationary arc is generated between the two electrodes.

In the illustrated embodiment, electrode 18 comprises an annular electrode and, as mentioned, is optionally cooled. For example, electrode 18 may have a central passageway with a diameter D in a range of 0.18 to 0.5 inches. Preferably, electrode 20 is centrally located in the passage so that it is equidistant to the inner surface of electrode 18. In order to cool electrode 18, electrode 18 preferably comprises an annular hollow electrode so that coolant, such as water, can be flowed through the electrode to thereby cool the electrode. In the illustrated embodiment, electrode 18 includes at least one inlet and one outlet for coupling to a coolant supply and for discharging the coolant after it has circulated through electrode 18.

In addition, as best seen in FIG. 2, in the illustrated embodiment electrode 18 is enclosed, at least partially, in a non-conductive, insulating material, such as a plastic jacket or cover 24. Suitable materials include TEFLON and insulating polymers, such as polypropylene, polyethylene or the like. Jacket 24 includes a cylindrical portion 26, in which electrode 18 is located, and a flange 28, which mounts electrode 18 in chamber 12. Flange 28 includes a central traverse opening 30 through which electrode 20 extends to extend through electrode 18. Flange 28 also includes a pair of transverse openings for receiving conduits 32a and 32b for coupling to inlets formed in annular electrode 18 for supplying coolant to electrode and for discharging circulated coolant from electrode 18. In addition, plasma generator 15 includes an inlet 34, such as an injection port that is coupled to flange 28 and mounted to flange 28 at central opening 30 for injecting an inert gas into the passageway in electrode 18 and into the arc generated between electrode 18 and electrode 20. For example, the inert gas may be injected into chamber 12 with a flow rate of 10 to 100 standard liters per minute and, more typically, with a flow rate of 30 to 70 standard liters per minute. In addition, the gas flow is preferably heated to several thousand degrees Celsius by the arc. In this manner, when a voltage is applied across electrodes 18 and 20, and the arc is generated between the two electrodes, the inert gas will form inert gas plasma jet 14. The length L of the jet can be controlled by varying the flow rate of the inert gas into the passageway and into the arc, which is chosen based on the chemical process to be employed downstream of the plasma jet. For example, in smaller applications length L may vary from 0.5 to 3.0 inches.

As noted above, plasma generator 15 is mounted in chamber 12 so that it generates a plasma jet in chamber 12. In addition, as will be more fully described below, plasma generator 15 is located in chamber 12 so that plasma jet 14 is generally aligned with an open ended tube 36 that is in communication with chamber 16 so that the compound(s) or substance(s) being acted on by the plasma jet are directed into chamber 16 where they are quenched, which will be more fully described below.

To introduce the compound(s) or substances(s) into jet 14, chamber 16 includes a process or feed inlet 38. Feed inlet 38 is preferably provided above jet 14 to provide a gravity feed of the compound(s) or substance(s), whether liquid, gas, solids, or a mixture thereof into chamber 12. It should be understood that the substance(s) may also be injected under pressure into chamber 12. When the substance, whether it is a combination of elements or compounds or a single compound, such as a waste, is injected through inlet 38, the substance initially flows into chamber 12 and then flows downward (as viewed in FIG. 1). Thereafter, the flow of the substance is deflected or redirected into jet 14 by flange 42, which results in the plasma jet and substance mixing at the jet and, further, results in the substance and plasma jet being directed into chamber 16 through tube 36 as indicated by the arrow in FIG. 1. Therefore, in addition to supporting tube 36 in chamber 12, flange 42 acts as a deflector or baffle. Preferably, as noted above, the arc between electrode 18 and electrode 20 is of sufficient magnitude to create a plasma jet when the inert gas flows through the arc.

The space below electrodes 18 and 20 represents a mixing region or area, which continues into tube 36. This mixing area can be fed with compressed air, water, or water vapor, to oxidize or instantaneously quench the substance being processed, depending on the required treatment of the substance, and also to cool tube 36, described more fully below.

In the illustrated embodiment, tube 36 comprises a straight round, cylindrical tube weldment with an annular flange 42 for mounting tube 36 between chambers 12 and 16. It should be understood that in some applications, it may be desirable for the tube to comprise an expansion tube to create a venturi effect, which could increase the flow of the substance(s) into the jet, but which would also create a turbulent flow and possible recirculation. The tube, for example, may be made from a metal, such as stainless steel, Hasteloy, or quartz or alumina, or even plastic, such as polypropylene. The selection of the material is typically dictated by the process variables, for example by the corrosiveness and/or reactivity of the substance or substances being processed. When processing highly corrosive substances, it may be beneficial to form tube 36 from plastic provided that the tube 36 can be adequately cooled. In addition, the tube may vary in length and/or in diameter over a wide range of dimensions depending on the application. For example, in smaller applications the tube may have a length in a range of 1 to 10 inches and more typically of about 3 inches. The diameter may vary to vary the flow through the tube. For example, in smaller applications the tube may have an inner diameter in a range of 0.25 to 0.6 inches depending on the specific process being employed. Further, the tube may be sized to create laminar or turbulent flow through the tube, with the turbulent flow providing increased mixing of the plasma jet and the substance or substances being processed. In addition, the upper open end of tube projects above flange 42 in a range or 0.060 to 1 inches and, more typically, in a range of 0.25 to 0.50 inches, again depending on the application and specific process being employed.

Chamber 12 preferably comprises a cylindrical chamber with a cylindrical wall 44 with an open upper end 45 and an inwardly extending lower flange 46. Mounted to open upper end 45 is jacket or cover 24. Chamber 16 similarly comprises a cylindrical chamber with a cylindrical wall 48 with a closed lower end and an inwardly extending upper flange 49 on which flange 46 is mounted. Chambers 12 and 16 may both be made of a variety of materials. Typical examples are stainless steel, Hasteloy, aluminum, and a variety of polymer plastic materials, such as polypropylene. The choice of the chamber material depends entirely on the gases that flow within the system. For example, polypropylene material would be a good choice when processing hydrogen fluoride (HF) gas or aqueous hydrogen fluoride, or other inorganic acids, vapors, or solutions.

Flange 42 of tube 36 is supported on flange 46 of chamber 12 to thereby divide the apparatus into the two chambers, which provide a reaction/mixing region and a product or products quenching region, with an annular seal 42a preferably located between flanges 42 and 46. In this manner, in the event that tube 36 needs replacement or repair, the tube may be simply lifted off flange 42 and replaced or repaired and returned. Flange 42 is typically made of high temperature withstanding material such as quartz, alumina, zirconia, stainless steel, Hasteloy metals, or other specialty metal alloys, or even plastic, such as polypropylene. This flange consists, as shown, of a flat disc of a typically thickness of 0.1 to 0.75 inches, with 0.25 inches being of practical use. Tube 36 is typically made of the same material as flange 42 and is secured, such as by welding, to flange 42. The diameter of the tube is chosen such that it can deliver laminar or turbulent flow within the tube. Therefore, this flange and tube, and in particularly the tube, acts as the central chemical reactor of this chemical abatement system.

As noted above, one or more substances may be injected into chamber 12 from feed inlet 38. In the present embodiment, as noted above, the injected substance(s) may comprise waste gases, liquid waste, solid waste, and a combination of liquid, solid, and gaseous products. Furthermore, a second feed inlet 50 is provided in chamber 12 to inject water and, optionally, a gas, such as compressed air or oxygen into chamber 12. Inlet 50 preferably comprises a T-shaped inlet with two ports 50a and 50b so that two mediums can be injected into chamber 12, such as water and a gas. The gas then atomizes the water, which is used to quench the resulting chemical or chemicals at the mixture point with jet 14. In addition, the gas or particulate stream to be processed is introduced as shown and may be mixed with the compressed dry air (CDA) in some cases, or an oxidant, such as pure oxygen, in other cases when oxidation of the substance or substances in the stream is desired, for example. In other cases, other suitable chemicals may be mixed with the argon ion stream through inlet 50. Water, vapor, and/or oxygen from inlet 50 may be used to quench and/or oxidize the chemical reactions occurring in the jet at the very mixing point of the plasma jet and the stream of the substance or substances being processed. Further, the water and/or vapor may be used to cool tube 36 and flange 42. For example, when processing highly corrosive substances, it may be preferable to form flange 42 and tube 36 from plastic so that the tube and flange are inert to the substance. However, the processing temperatures may exceed the maximum solid state temperature of the plastic. In this case, the water and/or vapor from inlet 50 may be used to cool the tube and flange so that the plastic material can be used in that environment. As will be described more fully below, in reference to FIG. 6 the second feed inlet may be relocated within the apparatus to achieve the same or similar effect.

When the substance is injected into apparatus 10 through inlet 38 and the substance encounters the plasma jet 14, the elements forming the substance are energized and also form a plasma, which discharges into or enters second chamber 16 through tube 36. As noted above, chamber 16 includes a quenching medium, which is injected into chamber 16 by inlet 52. Preferably, the quenching medium comprises a water or a water vapor. In this manner, when the plasma jet effects the disassociation (or association) of the substance (or substances), and the products (or product) are directed into chamber 16, the quenching medium reduces the temperature of the products in chamber 16, which reduces the reactivity of the product(s) thus leaving the product(s) in its (their) existing state. The resulting product(s) is then discharged from chamber 16 through exhaust port 54 for further optional processing.

Referring again to FIG. 1, chamber 12 also includes a third feed inlet 60 for injecting, for example water, into chamber 12. Water from inlet 60 may be used to cool the chamber, to clean the chamber, to at least partially fill or flood the chamber. To cool the chamber, water may be injected through inlet 60 so that the water merely trickles down the wall of the chamber. When chamber 12 is flooded or at least partially filled, and the whole jet is immersed, the resulting product or products may be instantaneously quenched. As would be understood, the plasma generator can be employed in a variety of different environments, including a pure gas stream, reactive or otherwise, or gas liquid atomized mixtures, or even under total immersion in a liquid, such as water or benzene. Therefore, inlet 60 may be used to fill, or at least partially fill chamber 12 with water to immerse generator 15. Optionally, as noted, water from inlet 60 may be used to clean and flush out suspended solids, such as silicon dioxide or other solids, to prevent them from clogging tube 36. For example, when silane is present and compressed air is injected in to chamber 12, the oxygen will combine with the silane molecules to form silicon dioxide, which is a white powdery substance, which can create clogging issues.

In this manner, by cleaning the apparatus, apparatus 10 may have prolonged operational life. Further, this feature reduces the frequency of the maintenance of apparatus 10, thus reducing the operations costs of apparatus 10 when processing semiconductor material and other materials containing hazardous water. This flushing may also be performed during the processing cycle or between abatement periods.

Referring to FIG. 4, the chemical synthesis process 110 of the present invention includes generating (112) an arc in chamber 12 and injecting an inert gas into the arc to form an inert plasma jet (114). At least two substances, such as a gas, liquid, or solid or combination thereof, are injected (116) in chamber 12. Preferably, the substances are mixed before reaching the jet. When the substances encounter jet 14, the chemical constituents of the substances are energized so that they are in a more reactive state. Since these reactive chemical constituents are mixed and, preferably, uniformly heated, they will combine to the desired compound (118). In other words, the chemical constituents forming the substances are associated as the desired compound. However, in order to stabilize the new association, the compound is then cooled or quenched (120) using the quenching medium, such as water, water vapor or the like, in chamber 16.

Referring to FIG. 5, the chemical abatement process (210) of the present invention includes generating an arc (212) and injecting an inert gas into the arc to form an inert plasma jet (214) in a processing chamber, such as processing chamber 12. A waste medium, such as a waste gas, liquid, or solid or combination thereof, is injected (216) in the processing chamber so that the waste medium will encounter the jet. By encountering the jet, the waste medium is transformed into a plasma in which the bonds between the chemical constituents, such as the compounds or elements, forming the waste medium are cleaved or broken such that the resulting products are no longer toxic or harmful. In other words, the chemical constituents forming the waste medium are disassociated (218). However, in order to reduce the reactivity of the plasma products and maintain or stabilize this disassociation, the plasma products are cooled or quenched (220) using a quenching medium such as water, water vapor or the like.

Referring to FIG. 6, the numeral 315 designates another embodiment of the plasma jet generator of the present invention. Plasma jet generator 315 is of similar construction to generator 15 and includes an annular negative electrode 318 and a generally centrally positioned positive electrode 320 that extends through electrode 318, which are housed in a plastic jacket or cover 324 with a cylindrical portion 326 and a flange portion 328 similar to generator 15. Flange 328 includes a central opening 330 through which electrode 320 extends and, further, through which the inert gas is injected by way of an injection port 334, which is mounted to flange 328. Injection port 334 is similar to injection port 34 and includes a first feed inlet 334a for injecting the inert gas into the space between the electrodes and includes a second feed inlet 350 for injecting water, vapor, and/or air.

Similar to inlet 50, inlet 350 comprises a T-shaped inlet, which allows for the dual injection of a gas, such as compressed air, including pure oxygen, and the water to quench and/or oxidize the very substances or substance being formed.

Inlet 350 is coupled to a conduit 351 that extends in the space between electrodes 318 and 320 but terminates between the distal end 320a of electrode 320 for directing the water, vapor, and/or air directly into the mixing point at jet 314, which is created by the inert gas flowing through the arc 319 formed between electrodes 318 and 320. Optionally, conduit 351 may include a deflector (not shown) for directing the flow of the water, vapor, and/or air stream into jet 314. Additionally, conduit 351 may include two lumens or passageways—one for directing the gas and/or water mixture in one direction and the other for directing the gas and/or water mixture in another direction. For example, one of the lumens may include associated therewith a deflector to direct the gas and/or water into the jet and the other lumen may include a nozzle or a deflector or diffuser to direct the gas and/or water, for example, to the tube to further cool the tube and flange. As noted above in reference to the first embodiment, when the tube and flange are formed from plastic material, it may be highly desirable to direct the flow of water or atomized water onto the tube and/or flange to thereby cool the flange or tube during certain types of processing.

Referring to FIG. 7, the numeral 415 designates another embodiment of the plasma jet generator of the present invention. Plasma jet generator 415 is of similar construction to generators 15 and 315 and includes an annular negative electrode 418 and a positive electrode 420 that extends through electrode 418. Electrodes 418 and 420 are housed in a plastic jacket or cover 424, which includes a cylindrical portion 426 and a flange portion 428 similar to generators 15 and 315. As described in reference to the previous embodiments, injection port 434 may be used to inject an inert gas into the passageway between electrode 418 and into the arc generated between electrode 418 and 420. For example, a suitable insert gas includes argon or nitrogen. When argon is injected, argon is injected with a steady state power. When nitrogen is rejected it can be injected with a low, pulsed power, which restarts re-ignition of the plasma jet automatically, which conserves power. Alternately, nitrogen may be injected with a high power steady state. For further details of injection port 434 and inlet 434a, reference is made to injection ports 34 and 334.

In the illustrated embodiment, second feed inlet 450 is coupled to an elongate conduit 451 that extends through electrode 418. Similar to the previous embodiments, inlet 450 includes two ports 450a and 450b for injecting a gas and water into conduit 451. Inlet feed 450 may also be used to inject methane or other hydrocarbons as a feed. For example, port 450a may be used to inject methane (CH₄) or other hydrocarbons, and port 450b may be used to inject oxygen or air, which includes nitrogen as well as oxygen. The result is a “plasma augmented flame”. This flame provides a stable flame that may also be operated under water.

In the illustrated embodiment, cover 424 includes and cylindrical portion 426 and a flange 428 similar to the previous embodiments and, further, includes a second inwardly extending flange 426a at its opposed end, which extends radially inward from cylindrical portion 426 to define therebetween an opening 426b through which jet 414 extends. Flange 426a is spaced from the distal end 418a of electrode 418, with the open end 451a of conduit 451 preferably located inwardly of the inner perimeter of flange 426a so that when the water/gas mixture is injected it flows into the space between flange 426a and electrode 418. This causes the water vapor mixture to be redirected or deflected it into jet 414 and, further, to envelope jet 414 as it flows through opening 426b and thereafter to cool flange 42 and tube 36. As described in reference to the first embodiment, the substance or substances to be mixed are injected through injection port 38 into chamber 12, which then flow downwardly in chamber 12 where the flow of the substance or substances impinges on flange 42. Flange 42 acts as a deflector or baffle to redirect the flow of the substance or substances radially inward toward the jet 414 where this mixes with jet 414, as described in reference to the first embodiment.

To source an oxidant, such as oxygen, or to source nitrogen, in any of the above referenced systems and methods, the present invention may optionally incorporate a gas generating system 500 for generating the oxidant, such as oxygen, or nitrogen. For example, a suitable oxygen generator includes pressure swing absorption (PSA) technology using zeolite, which can also be used to generate nitrogen, or a vacuum pressure swing absorption (VPSA) system.

The present invention, therefore, provides a method in which reactants are heated by an inert plasma jet, which raises the energy level of the chemical constituents of the substance or substances such that the bonds between chemical constituents are cleaved or joined with the chemical constituents of another substance to form a desired compound. The introduction of the quenching medium reduces the temperature in the associated or disassociated chemical constituents to reduce the likelihood of disassociation or reassociation, as would be understood. For example, the present invention is particularly useful for forming titanium dioxide.

It can be appreciated that the apparatus of the present invention can be used for chemical synthesis of compounds and also for the abatement of harmful and toxic waste. Examples of toxic wastes that can be abated and chemical compounds that can be synthesized using the present apparatus and process are numerous. For example, a flow of up to several hundred standard liters per minutes of Saline gas and nitrogen can be completely oxidized by injection of CDA or oxygen when mixed with the ion stream within the flange tube as shown. In this example, the product of ionic combustion is silicon dioxide solid suspended in the gas stream. However, such large particle dense stream can easily plug the flange tube as it does all other known gas abatement technologies existing today. The advantage of this flange reactor design is that it can absorb the high ion temperature impact within the center part of the abatement tube while being housed in a low temperature chemically inert plastic material. Should this flange corrode in long operating times, then it can be easily replaced with quickness and reduced cost. The argon or nitrogen ion plasma jet can be operated in a variety of ambient environments. Examples of such environments include pure gas stream, reactive or otherwise or gas liquid atomized mixtures, or even under total immersion in liquids such as water. The argon or nitrogen ion flow would not be extinct under such conditions as happens when methane flames are used in the existing technologies. However, one of the applications is to inject air together with the CDA or oxygen streams. The water flow is typically atomized and spread equally within CDA stream as it enters the flange tube where it mixes with the process gas and the argon or nitrogen ion stream. The flow of water quenches chemical reactions being present at the very mixing point of all these streams and effecting disequilibrium conversion of oxidized or dissociated process stream molecules. This helps in the efficient formation and separation of silicon dioxide when silane is present in the feed stream, and removing fluorine ions when fluorinated compounds are dissociated in such abatement systems. The water also assists significantly in cooling down the flange enabling long term operation when chemically inert plastic material are used for cost and operational effectiveness. Furthermore, the present of water helps to clean and flush out suspended solids such as silicon dioxide or other solids and prevent them from clogging this tube thus prolonging the operational life time of this abatement system. This novel feature reduces the need for frequent maintenance and thus reduces the cost of operation for such systems as they are used in the processing of semiconductors and other material containing hazardous wastes.

As described, toxic waste can be input into the feed stream of the present system and completely converted into active elemental reaction products immediately after which these reaction products can be (a) oxidized further to stabilize these harmless products by mixing them with oxygenated gas to produce stable products, (b) reduced by mixing them with a hydrogen donor reducing compound to produce the desired stable product or (c) immediately quenched using water or an alkaline water solution scrubbed by pure water or an alkaline water solution. The final output from the system, in this case, may then directed for further treatment, for example treatment for acid or base neutralization.

Further, as previously mentioned, methane may be used in conjunction with the present invention to produce a plasma augmented flame. This flame also works under water, so that the water cleans the particle generation. This flame can also be used in conjunction with oxygen, such as oxygen produced by an oxygen generator.

While several forms of the invention have been shown and described, other forms will now be apparent to those skilled in the art. For example, as described, water flush and clean injection streams can be added above the flange and below it for enhanced cleaning of heavy laden particle streams and products. This can be performed during the processing cycle or in between abatement periods. Further, while described in reference to inert gases used as the ion stream, other gases may also be used. Therefore, it will be understood that the embodiments shown in the drawings and described above are merely for illustrative purposes, and are not intended to limit the scope of the invention which is defined by the claims which follow as interpreted under the principles of patent law including the doctrine of equivalents.

I claim:

1. A chemical scrubbing apparatus comprising:
a first chamber configured to generate a non-rotating arc therein;
a second chamber in communication with said first chamber;
a gas injector injecting a first gas into said arc to generate a plasma jet;
a first inlet for injecting a substance into said first chamber;
a mixing region, the substance mixing with said plasma jet in said mixing region whereby said plasma jet disassociates the chemical constituents of the substance in said mixing region, said mixing region directing said chemical constituents into said second chamber, and said second chamber adapted to quench the chemical constituents to reduce the reactivity of the chemical constituents to thereby maintain their disassociation; and
a second inlet for directing a second gas and/or water into said first chamber at said mixing region.

2. The chemical scrubbing apparatus according to claim 1, wherein said second inlet injects water into the mixing region.

3. The chemical scrubbing apparatus according to claim 1, wherein said mixing region includes a tube, said tube providing communication between said first chamber and said second chamber.

4. The chemical scrubbing apparatus according to claim 3, wherein said second inlet is adapted to inject water into said first chamber for cooling said tube.

5. The chemical scrubbing apparatus according to claim 3, wherein said tube includes a flange, said flange mounting said tube between said chambers.

6. The chemical scrubbing apparatus according to claim 5, wherein said flange deflects the flow of the substance into said mixing region.

7. The chemical scrubbing apparatus according to claim 5, wherein said tube includes a proximate end in proximity to said plasma jet and a distal end, said distal end extended into said second chamber.

8. The chemical scrubbing apparatus according to claim 7, wherein said distal end of said tube is immersed in a quenching medium in said second chamber.

9. The chemical scrubbing apparatus according to claim 4, wherein said tube comprises a tube formed from a material chosen from stainless steel, Hasteloy, quartz, alumina, or plastic.

10. The chemical scrubbing apparatus according to claim 9, wherein said tube comprises plastic.

11. The chemical scrubbing apparatus according to claim 10, wherein said tube comprises polypropylene.

12. The chemical abatement apparatus according to claim 1, further comprising:
a negative electrode and a positive electrode positioned in said first chamber, said electrodes selectively generating an arc there between for forming the plasma jet.

13. The chemical scrubbing apparatus according to claim 12, wherein said negative electrode comprises an annular electrode, said positive electrode passing through at least a portion of said negative electrode.

14. The chemical scrubbing apparatus according to claim 13, wherein said first inlet injects the first gas between said positive electrode and said negative electrode.

15. The chemical scrubbing apparatus according to claim 14, wherein said second inlet injects water and/or gas into said chamber through said annular electrode.

16. The chemical scrubbing apparatus according to claim 1, further comprising a gas generator for generating a gas, said gas generator generating either (a) an oxidant or (b) nitrogen, said gas generator coupled to said first chamber for delivering the gas to the first chamber.

17. A chemical synthesis apparatus comprising:
a first chamber configured to generate a plasma jet therein;
a second chamber in communication with said first chamber;
a mixing region;
a first inlet for injecting at least two substances into said first chamber and into said jet whereby said jet transforms said substances into a compound in said mixing region, said compound thereafter flowing into said second chamber;
a second inlet for injecting water and/or gas into said first chamber into said mixing region; and
said second chamber configured to quench said compound when said compound is in said second chamber to thereby stabilize said compound.

18. The chemical synthesis apparatus according to claim 17, wherein said second inlet injects water for quenching said compound in said mixing region and for cooling said apparatus.

19. The chemical synthesis apparatus according to claim 18, wherein said first chamber includes a negative electrode, a positive electrode extending through at least a portion of said negative electrode, and an injection port for injecting a gas between said electrodes, said electrodes adapted to couple to a power source for generating an arc, and said arc generating a plasma jet when said gas is flowed through said arc.

20. The chemical synthesis apparatus according to claim 19, further comprises a tube, said plasma jet and said substances mixing in said tube, and said tube directing said compound formed by said plasma jet and said substances into said second chamber.

21. The chemical synthesis apparatus according to claim 20, further comprising a flange, said flange dividing said apparatus into said first and second chambers, and said flange supporting said tube between said chambers.

22. The chemical synthesis apparatus according to claim 21, wherein said flange deflects the flow of the substances into said plasma jet.

23. The chemical synthesis apparatus according to claim 22, wherein said second inlet injects water for cooling said flange and said tube.

24. The chemical synthesis apparatus according to claim 21, wherein said tube injects the compound into a quenching medium in said second chamber.

25. The chemical synthesis apparatus according to claim 20, further comprising a gas generator for generating a gas, said gas generator generating either (a) an oxidant or (b) nitrogen, said gas generator coupled to said first chamber for delivering the gas to the first chamber.

26. A method of chemical abatement comprising the steps of:
generating a gas ion stream;
flowing a waste medium into the gas ion stream;
mixing the waste medium with the gas ion stream in a mixing region to disassociate the chemical constituents of the waste medium into a non-toxic form; and
quenching the chemical constituents to stabilize the disassociated state of the chemical constituents.

27. The method of chemical abatement according to claim 26, wherein said generating a gas ion stream comprises generating an inert gas ion stream.

28. The method of chemical abatement according to claim 26, further comprising flowing the chemical constituents into a second chamber.

29. The method of chemical abatement according to claim 28, wherein said flowing includes directing the chemical constituents into the second chamber through a tube.

30. The method of chemical abatement according to claim 29, further comprising cooling the tube.

31. The method of chemical abatement according to claim 28, wherein said quenching includes exposing the chemical constituents to one chosen from water and water vapor.

32. The method according to claim 26, further comprising generating oxygen, and injecting the oxygen into the mixing region.

33. The method of chemical synthesis is according to claim 26, wherein said generating a gas ion stream includes generating an arc and flowing a gas into the arc.

34. The method of chemical synthesis according to claim 33, wherein said flowing a gas includes flowing an inert gas into the arc.

35. A method of chemical synthesis comprising:
generating a gas ion stream;
flowing at least two substances into the gas ion stream;
mixing the gas ion stream and the substances to energize the substances to a more reactive state whereby the substances associate to form a chemical compound; and
quenching the chemical compound to stabilize the chemical compound in its existing form.

36. The method of chemical synthesis according to claim 35, further comprising directing water and/or a gas into the mixing region to quench the chemical compound in the mixing region to thereby quench the chemical compound.

37. The method of chemical synthesis according to claim 35, further comprising flowing the chemical compound into a second chamber.

38. The method of chemical synthesis according to claim 37, wherein flowing the chemical compounds includes flowing the chemical compound in the second chamber with laminar flow.

39. The method of chemical synthesis according to claim 38, further comprising generating oxygen, and injecting the oxygen into the mixing region.

40. A chemical synthesis apparatus comprising:
a chamber configured to generate a gas ion stream;
a mixing region;
a first inlet for injecting at least two substances into said chamber and into said gas ion stream whereby said ion stream transforms said substances into a compound in said mixing region, said compound thereafter flowing into said second chamber;
an oxidant generator for generating an oxidant;
a second inlet for injecting at least the oxidant into said first chamber into said mixing region; and
said apparatus adapted to quench said compound to thereby stabilize said compound.

41. The chemical synthesis apparatus according to claim 40, further comprising a second chamber, said mixing region directing the compound into said second chamber, and said second chamber configured to quench said compound when said compound is in said second chamber to thereby stabilize said compound.

42. The chemical synthesis apparatus according to claim 40, wherein said oxidant generator comprises an oxygen generator.

43. The chemical synthesis apparatus according to claim 42, wherein said gas ion stream comprises an inert plasma jet.

44. A chemical scrubbing apparatus comprising:
a chamber configured to generate a gas ion stream;
a mixing region;
a first inlet for injecting a waste medium into said chamber and into said gas ion stream whereby said ion stream disassociates the chemical constituents of the waste medium in said mixing region;
an oxidant generator for generating an oxidant;
a second inlet for injecting the oxidant into said mixing region; and
said apparatus being adapted to quench the chemical constituents to reduce the reactivity of the chemical constituents to thereby maintain their disassociation.

44. The chemical synthesis apparatus according to claim 43, wherein said oxidant generator comprises an oxygen generator.

45. The chemical synthesis apparatus according to claim 44, wherein said gas ion stream comprises an inert plasma jet.

46. The chemical synthesis apparatus according to claim 45, further comprising a second chamber, said mixing region directing the chemical constituents into said second chamber, and said second chamber configured to quench said chemical constituents when in said second chamber to reduce the reactivity of the chemical constituents and thereby maintain their disassociation.
